(19) United States
(12) Patent Application Publication
(10) Pub. No.: US 2013/0074936 A1
(43) Pub. Date: Mar. 28, 2013

(54) MIS-FILL PREVENTION SYSTEM

(71) Applicants: Jack A. Merchant, Peoria, IL (US); Randy L. Marquis, Dunlap, IL (US)

(72) Inventors: Jack A. Merchant, Peoria, IL (US); Randy L. Marquis, Dunlap, IL (US)

(73) Assignee: Caterpillar Inc., Peoria, IL (US)

(21) Appl. No.: 13/246,300

(22) Filed: Sep. 27, 2011

(51) Int. Cl. F16K 17/00

(52) U.S. Cl. 137/1; 137/455

(57) ABSTRACT

A reductant delivery and supply system including a storage tank, a pump, a dosing module, and a mis-fill prevention system. The storage tank stores a fluid. The pump is coupled to the storage tank by a delivery line. The dosing module is coupled to the pump by a supply line. The mis-fill prevention system includes an expandable plug. The expandable plug is configured in contact with the fluid. Moreover, the expandable plug is configured to expand on contact with a hydrocarbon.

### TECHNICAL FIELD

The present disclosure relates to an exhaust aftertreatment system of an engine, and more specifically relates to a reductant delivery and supply system.

### BACKGROUND

Environmental regulations on emissions control have lead to the development of various technologies, such as a Selective Catalytic Reduction (SCR) system. An SCR system may be included in an engine aftertreatment system of a power system to remove or reduce nitrous oxide (NOₓ or NO) emissions present in the exhaust gases coming from an engine. The power system may further include a reductant delivery and supply system to introduce a liquid reductant, such as urea, into the SCR system.

U.S. Pat. No. 7,861,516 (the '516 patent) discloses an SCR system to reduce NOₓ and NO present in exhaust gases of an engine. The '516 patent further discloses a reductant delivery and supply system to control a reductant supply into the exhaust gases, upstream of the SCR system, based on a temperature of the exhaust gases at an inlet of the SCR system.

However, an inadvertent introduction of a hydrocarbon based fuel in the reductant delivery and supply system and/or in the SCR system may lead to damage of the SCR system.

### SUMMARY OF THE DISCLOSURE

In one aspect, the present disclosure provides a reductant delivery and supply system including a storage tank, a pump, a dosing module, and a mis-fill prevention system. The storage tank is configured to store a fluid. The pump is coupled to the storage tank by a delivery line. The dosing module is coupled to the pump by a supply line. Further, the mis-fill prevention system includes an expandable plug configured in contact with the fluid. The expandable plug is configured to expand on contact with a hydrocarbon.

In another aspect, the disclosure provides a method for preventing mis-fill in a reductant delivery and supply system. The method includes providing an expandable plug configured in contact with a fluid. Further, the method includes expanding the expandable plug on contact with a hydrocarbon.

Other features and aspects of this disclosure will be apparent from the following description and the accompanying drawings.

### BRIEF DESCRIPTION OF THE DRAWINGS

FIG. 1 is a diagrammatic view of an arrangement of an expandable plug in a delivery line of a reductant delivery and supply system, according to an aspect of the disclosure;

FIG. 2 is a diagrammatic view of the expandable plug in an expanded state in relation to the arrangement shown in FIG. 1;

FIG. 3 is a another arrangement of the expandable plug in a supply line of the reductant delivery and supply system, according to another aspect of the disclosure;

FIG. 4 is a diagrammatic view of the expandable plug in an expanded state in relation to the another arrangement shown in FIG. 3; and

FIG. 5 is a process flow diagram for preventing mis-filling of the reductant delivery and supply system.

### DETAILED DESCRIPTION

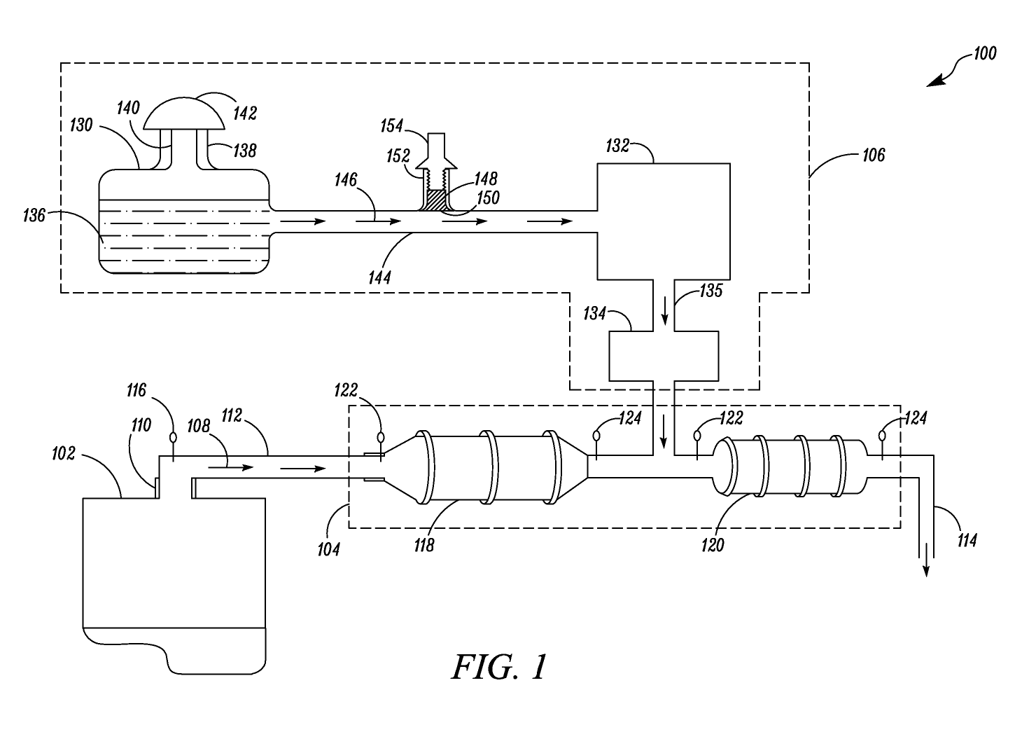

FIGS. 1-4 illustrate various embodiments of the present disclosure, having a power system 100 including an engine 102, an aftertreatment system 104 and a reductant delivery and supply system 106. The engine 102 may include other features not shown, such as fuel systems, air systems, insulating systems, drivetrain components, turbochargers, peripheries etc. The engine 102 may be any type of engine (internal combustion, gas, diesel, gaseous fuel, natural gas, propane, etc.), may be of any size, with any number of cylinders, and in any configuration (“V,” in-line, radial, etc.). The engine 102 may be used to power any machine or other device, including on-highway trucks or vehicles, off-highway trucks or machines, earth moving equipment, generators, aerospace applications, locomotive applications, marine applications, pumps, stationary equipment, or other engine powered applications.

The aftertreatment system 104 is used to treat an exhaust stream 108 which leaves the engine 102 at an exhaust outlet 110 and enters an exhaust conduit 112 of the aftertreatment system 104. In one embodiment, the exhaust stream 108 may exit the engine 102 through an exhaust manifold (not shown) coupled with the engine 102. The exhaust stream 108 generally contains emissions which may include NOx, unburned hydrocarbons, and particulate matter. The aftertreatment system 104 is generally designed to reduce the content of NOx, unburned hydrocarbons, particulate matter, or other components of the emissions prior to the exhaust stream 108 exiting the power system 100 at a tailpipe 114.

Further, an engine out NOx sensor 116 may be located near the exhaust stream outlet 110 as shown. The engine out NOx sensor 116 may provide information regarding the NOx concentration in the exhaust stream 108 passing through the exhaust conduit 112 via a communication line to a controller (not shown). Moreover, the controller may receive information from a plurality of other sensors, for example, the sensors may include NOx, O₂ and various other sensors coupled in the exhaust conduit 112. Other sensors such as pressure and temperature sensors may also be included without any limitation. The controller may receive the information from the plurality of sensors, process the received information and correspondingly trigger one or more actuators via the communication lines. The actuators may include fuel injectors, reductant injectors, reductant line heaters, and the like. In an embodiment, the controller may be a microcomputer including a microprocessor unit, input and output ports, an electronic storage medium for executable programs and calibration values, random access memory, a data bus, and the like. The controller may also include a routine for controlling and/or diagnosing one or more components of the aftertreatment system 104.

In an embodiment, the aftertreatment system 104 may include a filter, generally a diesel particulate filter (DPF) 118, and a selective catalytic reduction (SCR) module 120. The DPF 118 may be coated with a suitable catalyst to promote oxidation of any particulate matter in the exhaust stream 108 that may be trapped in the DPF 118. The SCR module 120 may include a catalyst for facilitating the reaction, reduction, or removal of NOx emissions from the exhaust stream 108 as it passes through the SCR module 120. The SCR module 120 may have a honeycomb or other structure made from or coated with an appropriate material. The material may be an oxide, such as vanadium oxide or tungsten oxide, coated on an appropriate substrate, such as titanium dioxide. Moreover, the aftertreatment system 104 may include temperature sensors 122 and 124 located adjacent to an inlet and outlet of the DPF 118 and SCR module 120, respectively. The temperature sensors 122 and 124 may communicate exhaust temperatures to the controller via communication lines.

A person of ordinary skill in the art will appreciate that the aftertreatment system 104 may be disposed in various orders and/or combinations relative to the exhaust conduit 112. For example, the aftertreatment system 104 may further include a diesel oxidation catalyst (DOC). In such an exemplary embodiment, the DOC may be followed downstream by the SCR module 120. Alternatively, the aftertreatment system 104 may omit the DPF 118 and include only the SCR module 120. In yet another exemplary embodiment, a combined DPF/SCR catalyst (not shown) may be used. The aftertreatment system 104 shown in FIGS. 1-4 are merely on an exemplary basis. The aforementioned variations in the position and the components included in the aftertreatment system 104 are possible without deviating from the scope of the disclosure and various other non-described configurations are also possible within the scope of this disclosure.

As shown in FIGS. 1-4, the reductant delivery and supply system 106 may further include a storage tank 130, a pump 132 and a dosing module 134 for supplying a fluid 136 in the aftertreatment system 104. The fluid 136 may be a liquid reductant such as diesel exhaust fluid (DEF), comprising urea. Alternative liquid reductants may comprise ammonia or any other reducing agent. The storage tank 130 is configured to store the fluid 136. Moreover, in order to fill in the fluid 136 in the storage tank 130, the storage tank 130 may be provided with a filler neck 138. The filler neck 138 may encompass a filler line 140. The filler line 140 may receive a supply of the fluid 136 through an external nozzle. In an embodiment, the filler neck 138 may also be fitted with a filler cap 142 to prevent vaporization of the fluid 136. In one exemplary embodiment, the storage tank 130 may be placed in proximity to the fuel tank in the power system 100 in order to provide a convenient refilling location for an operator. In an embodiment, the storage tank 130 may be thermally insulated by any suitable means in order to maintain the fluid 136 at a threshold temperature. Other parameters related to the storage tank 130 such as size, shape, location, and material used may vary within the scope of the disclosure.

The storage tank 130 may be fluidly coupled to the pump 132 by a delivery line 144. The pump 132 may be used to pressurize and deliver the fluid 136, thereby forming a fluid flow 146 through the delivery line 144. For easy flow of the fluid 136, the delivery and supply system 106 may also include other components. For example, a heater may be provided in the delivery line 144 to warm the fluid 136 as it flows towards the pump 132 to maintain optimal viscosity of the fluid 136. Size, resistance and length of the heater may vary with the position, width, and length of the delivery line 144.

Downstream of the fluid flow 146, the pump 132 is fluidly coupled to the dosing module 134 via a supply line 135. In an embodiment, the delivery line 144 and/or the supply line 135 may be a channel that is formed in a block connecting the storage tank 130 to the pump 132 or the pump 132 to the dosing module 134 respectively. In another embodiment, the delivery line 144 and/or the supply line 135 may include a hose made of plastic, rubber, or the like. A person of ordinary skill in the art will appreciate that any other construction of the delivery line 144 and/or the supply line 135 primarily forming a passage for the fluid flow 146 in the reductant delivery and supply system 106 may be used. In different embodiments, parameters such as the length, width, and position of the delivery line 144 and/or the supply line 135 may vary.

The dosing module 134 may include an injector to inject the fluid 136 into the exhaust stream 108 entering the SCR module 120. As shown in FIGS. 1-4 the dosing module 134 may be located upstream relative to the SCR module 120. As described above, the dosing module 134 may receive control signals from the controller in order to control the timing and amount of the fluid 136 to be injected into the exhaust stream 108. In an embodiment, a mixer pipe may be provided downstream from the dosing module 134 to promote mixing of the fluid 136 with the exhaust stream 108 prior to entry into the SCR module 120.

According to an aspect of the present disclosure, an expandable plug 148 may be configured in contact with the fluid 136. In an embodiment, the expandable plug 148 may include ethylene propylene diene monomer rubber. The expandable plug 148 may be shaped such that it has at least one surface 150 in contact with the fluid 136. The shape, size and dimensions of the expandable plug 148 may vary without deviating from the scope of the present disclosure. Moreover, in an embodiment, the expandable plug 148 may be placed at a T-junction formed between the delivery line 144 and an outlet line 152 fitted with a bolt 154. The bolt 154 may be provided with outer threads in order to fit with inner threads provided on the outlet line 152 and rigidly hold the expandable plug 148 to be exposed to the fluid flow 146.

When the fluid 136 flows through the delivery line 144, the surface 150 of the expandable plug 148 is in contact with the fluid flow 146 and the plug expansion is unaffected by a flow of fluid thereby, i.e., the expandable plug 148 neither expands nor contracts. However, errors may be made that result in the mis-filling of the storage tank 130. For example, the storage tank 130 may be mis-filled with a hydrocarbon, such as a diesel fuel rather than with the reductant.

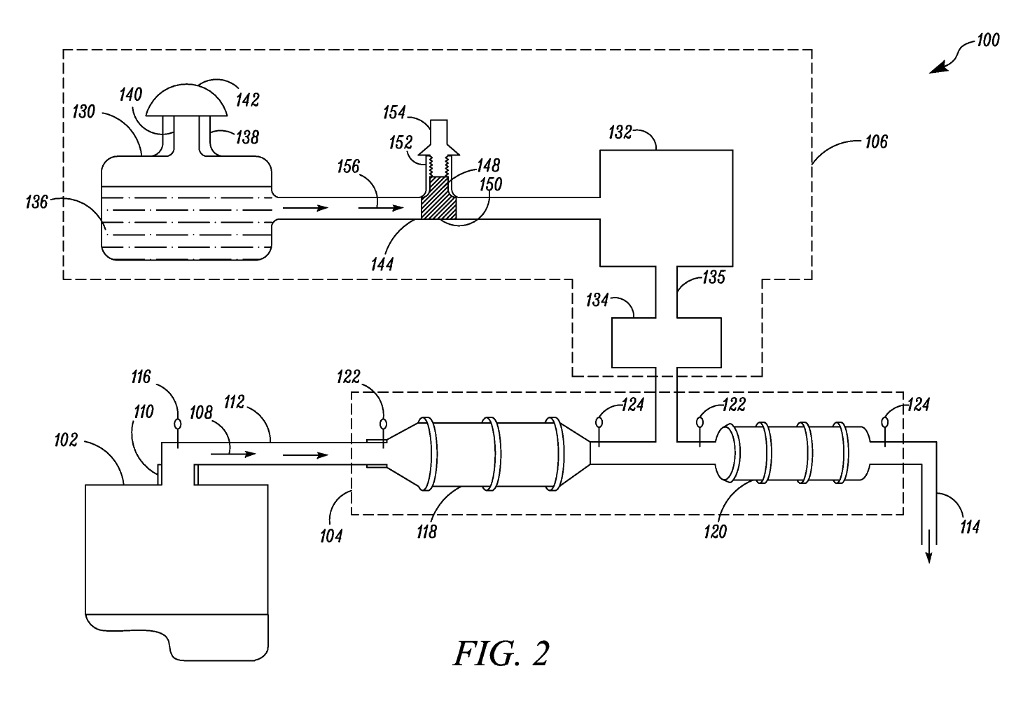

As shown in FIG. 2, in the event of a mis-filling event a contaminated flow 156 passes through the delivery line 144 towards the pump 132. The contaminated flow 156 may be a combination of reductant and hydrocarbon or pure hydrocarbon. As shown in FIG. 2, when the surface 150 of the expandable plug 148 comes in contact with the hydrocarbon present in the contaminated flow 156, the expandable plug 148 expands and blocks the delivery line 144, thereby preventing the contaminated flow 156 from entering the pump 132.

In an embodiment, wherein the delivery line 144 is in the form of a hose, the contaminated flow 156 may be collected in the delivery line 144. In an embodiment, the hose may be detached from the T-junction to clean and purify the delivery line 144. Alternatively, the contaminated flow 156 may be sucked out of the delivery line 144 using a suitable means. The expanded expandable plug 148 may be removed via the outlet line 152 using the bolt 154, and can be replaced with a new one. The aforementioned techniques are merely on an exemplary basis. It should be noted that there may be other methods to dislodge the expanded expandable plug 148 or to remove the contaminated flow 156 in the delivery line 144.

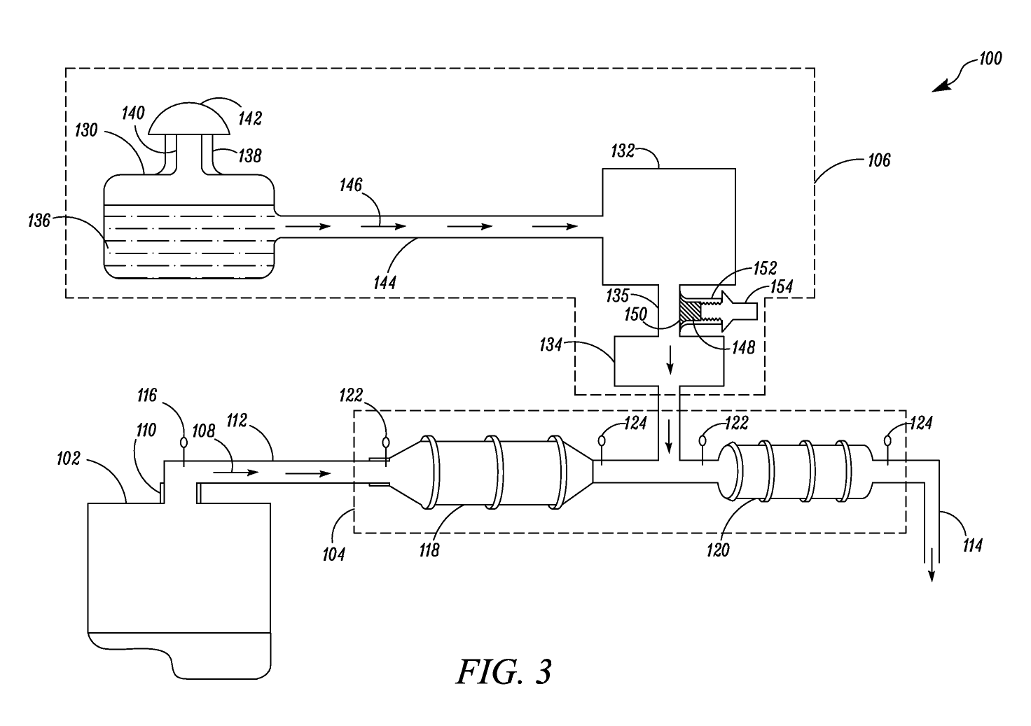

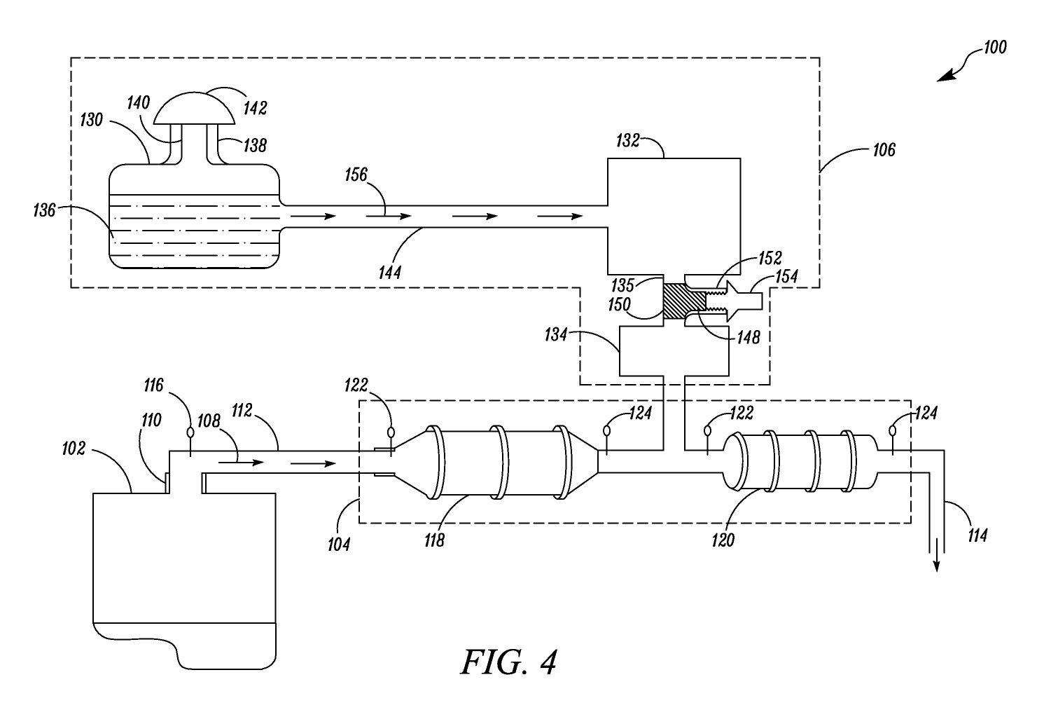

The FIGS. 3 and 4 show an alternative arrangement in which the expandable plug 148 is placed in the supply line 135. As shown in FIG. 3, the surface 150 of the expandable plug 148 is in contact with the fluid 136 as it flows towards the dosing module 134 from the pump 132. FIG. 4 is analogous to the description provided in connection with FIG. 2, wherein the expandable plug 148 expands on contact with the hydrocarbon, thereby blocking the contaminated flow 156 from entering the dosing module 134.

It may be apparent to one of ordinary skill in the art that the two arrangements shown in FIGS. 1 and 3 may either be used separately or in combination with one another. Moreover, in an embodiment, the expandable plug 148 may be placed in the filler neck 138 or filler cap 142 to prevent the mis-fill of the storage tank 130. In the event that the storage tank 130 is mis-filled with the hydrocarbon, the expandable plug 148 may expand and prevent the hydrocarbon from entering the storage tank 130 and the aftertreatment system 104.

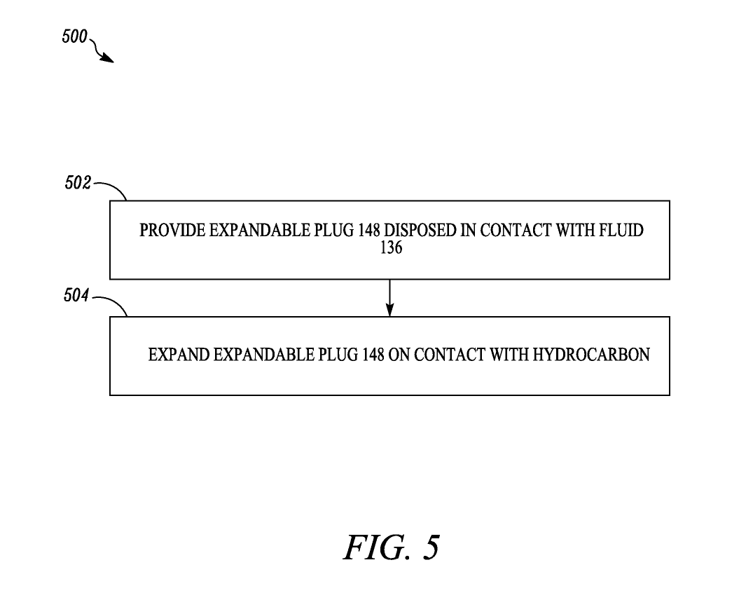

FIG. 5 illustrates a method 500 for preventing mis-filling in the reductant delivery and supply system 106. The fluid flow 146 caused by the pump 132, originates from the storage tank 130. In the reductant delivery and supply system 106, the fluid flow 146 is through the delivery line 144 towards the pump 132. The fluid flow 146 is also through the supply line 135 connecting the pump 132 to the dosing module 134.

In step 502, the expandable plug 148 is configured in contact with the fluid 136. As explained above, the surface 150 of the expandable plug 148 is in contact with the fluid 136 as the fluid 136 flows through the delivery line 144 and/or the supply line 135. In an embodiment, the expandable plug 148 may be placed in the delivery line 144, as shown in FIG. 1. Moreover, the expandable plug 148 may also be placed in the supply line 135 as shown in FIG. 3. In another embodiment, the expandable plug may also be placed in the filler neck 138 or filler cap 142 of the storage tank 130. Depending on the need, one or more of the expandable plugs 148 may be placed either in combination, or separately in each of the aforementioned arrangements.

In step 504, in case of any contamination with the hydrocarbon, the expandable plug 148 configured in contact with the fluid 136 expands and enlarges in size. The expanded expandable plug 148 blocks the delivery line 144 and/or the supply line 135, thus preventing the contaminated flow 156 in the reductant delivery and supply system 106 from entering the pump 132 and the dosing module 134, respectively. In an embodiment, the blocking of the contaminated flow 156 may protect the SCR module 120 of the aftertreatment system 104 from getting damaged by the hydrocarbon.

### INDUSTRIAL APPLICABILITY

During operation of the power system 100, the fluid 136 stored in the storage tank 130 may be utilized in the treating the exhaust stream 108. Hence, the storage tank 130 may require periodic re-filling from an external source as the fluid 136 is used during operation of the power system 100. This filling of the fluid storage tank 130 is done manually. Due to an inadvertent error, the storage tank 130 may be incorrectly filled with diesel fuel or any other hydrocarbon. If introduced into the aftertreatment system 104, diesel fuel in particular may cause irreparable damage to the SCR module 120 of the power system 100. The presence of the diesel fuel or any other impurity may degrade the quality of the reductant, adversely affecting the aftertreatment system 104 performance. In extraordinary cases, the introduction of diesel fuel into the SCR module 120 may lead to an exothermic reaction. Moreover, the contamination may also lead to degradation of components in the aftertreatment system 104, reducing their integrity and thereby causing leaks and spills.

The mis-fill prevention system according to the present disclosure, including the expandable plug 148 which is configured in contact with the fluid 136, may be effective in preventing the introduction of hydrocarbon or diesel fuel from entering the SCR module 120 of the aftertreatment system 104. In an embodiment, the expandable plug 148 may include the ethylene propylene diene monomer rubber, further proving to be a cost effective solution.

The placement of the expandable plug 148 in the reductant delivery and supply system 106 may vary depending on the components of the power system 100 being protected. As shown in FIG. 1, placing the expandable plug 148 in the delivery line 144 results in effective protection of the aftertreatment system 104. In case of contamination by the hydrocarbon, the hydrocarbon is substantially prevented to flow towards the pump 132. The expandable plug 148 may have a response time of about 0.5 to 2 seconds, thereby safe guarding the aftertreatment system 104 by early detection of the contamination. However, the response time of the expandable plug 148 may vary depending upon a size and/or composition of the expandable plug 148.

Moreover, by placing the expandable plug 148 in the supply line 135, the SCR module 120 may be protected from damage and contamination by the hydrocarbon. The expandable plug 148 may also be placed in the filler neck 138 or the filler cap 142 of the storage tank 130, in order to prevent the hydrocarbon from being circulated in the power system 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A reductant delivery and supply system comprising:
a storage tank configured to store a fluid;
a pump which is coupled to the storage tank by a delivery line;
a dosing module which is coupled to the pump by a supply line; and
a mis-fill prevention system including:
an expandable plug configured to contact the fluid wherein the expandable plug is configured to expand on contact with a hydrocarbon.

2. The reductant delivery and supply system of claim 1, wherein the fluid includes a diesel exhaust fluid.

3. The reductant delivery and supply system of claim 1, wherein the hydrocarbon includes a diesel fuel.

4. The reductant delivery and supply system of claim 1, wherein the expandable plug includes ethylene propylene diene monomer rubber.

5. The reductant delivery and supply system of claim 1, wherein the expandable plug is located in the delivery line.

6. The reductant delivery and supply system of claim 1, wherein the expandable plug is located in the supply line.

7. The reductant delivery and supply system of claim 1, wherein the storage tank includes a filler neck, the filler neck is fluidly coupled to the storage tank and the expandable plug is located in the filler neck.

8. A mis-fill prevention system configured for use in a reductant delivery and supply system, the mis-fill prevention system comprising:
an expandable plug configured to contact a fluid wherein the expandable plug is configured to expand on contact with a hydrocarbon

9. The mis-fill prevention system of claim 8, wherein the fluid includes a diesel exhaust fluid.

10. The mis-fill prevention system of claim 8, wherein the hydrocarbon includes a diesel fuel.

11. The mis-fill prevention system of claim 8, wherein the expandable plug includes ethylene propylene diene monomer rubber.

12. The mis-fill prevention system of claim 8 further including:
a storage tank configured to store the fluid;
a pump coupled to the storage tank by a delivery line; and
a dosing module which is coupled to the pump by a supply line.

13. The mis-fill prevention system of claim 12, wherein the expandable plug is located in the delivery line.

14. The mis-fill prevention system of claim 12, wherein the expandable plug is located in the supply line.

15. The mis-fill prevention system of claim 12, wherein the storage tank includes a filler neck, the filler neck is fluidly connected to the storage tank and the expandable plug is located in the filler neck of the storage tank.

16. A method for preventing mis-fill in a reductant delivery and supply system, the method comprising:
providing an expandable plug configured to contact a fluid; and
expanding the expandable plug on contact with a hydrocarbon.

17. The method for preventing miss-fill in a reductant delivery and supply system of claim 16, further includes:
storing the fluid in a storage tank;
generating a fluid flow using a pump coupled to the storage tank by a delivery line; and
supplying the fluid flow to a dosing module coupled to the pump by a supply line.

18. The method for preventing miss-fill in a reductant delivery and supply system of claim 17, wherein providing the expandable plug configured to contact the fluid includes providing the expandable plug in the delivery line.

19. The method for preventing miss-fill in a reductant delivery and supply system of claim 17, wherein providing the expandable plug configured to contact the fluid includes providing the expandable plug in the supply line.

20. The method for preventing miss-fill in a reductant delivery and supply system of claim 17, wherein providing the expandable plug configured to contact the fluid includes providing the expandable plug in a filler neck fluidly connected to the storage tank.
